(19) United States
(12) Patent Application Publication
(10) Pub. No.: US 2010/0125402 A1
(43) Pub. Date: May 20, 2010

(54) SYSTEM AND METHOD FOR CONTROLLING VEHICLE ENGINE RUNNING STATE AT BUSY INTERSECTIONS FOR INCREASED FUEL CONSUMPTION EFFICIENCY

(75) Inventors: Ravi P. Bansal, Tampa, FL (US); Salil Gandhi, Pune (IN); Saidas Kottawar, Maharashtra (IN); Sandip D. Mahajan, Nagpur (IN)

Correspondence Address: IBM CORPORATION US;c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/271,498

(22) Filed: Nov. 14, 2008

(51) Int. Cl. G08G 1/09

(52) U.S. Cl. 701/117

(57) ABSTRACT

The present disclosure is directed to a method for managing engines in response to a traffic signal. The method may comprise establishing communications with participating vehicles; responding to a stop status indicated by the traffic signal, further comprising: receiving a position data from each participating vehicles; determining a queue of participating vehicles stopped at the traffic signal; determining a remaining duration of the stop status; sending a stop-engine notification to the list of participating vehicles stopped at the traffic signal when the remaining duration is greater than a threshold of time; responding to a proceed status indicated by the traffic signal, further comprising: sending a start-engine notification to a first vehicle in the queue; calculating an optimal time for an engine of a second vehicle in the queue to start; and sending the start-engine notification to the second vehicle at the optimal time.

### TECHNICAL FIELD

The present disclosure generally relates to the field of computer technology, and more particularly to a method for managing vehicle engines in response to a traffic signal.

### BACKGROUND

Vehicle fuel consumption is a major component of global energy consumption. With increasing vehicle usage, there may be more traffic and longer wait times at traffic signals (e.g., at a traffic intersection or a railway crossing). Fuel may be wasted when drivers keep their vehicles running while waiting for the traffic signal to turn “green” or waiting for a train to pass at a railway crossing. Most drivers may not switch off their engines in these situations. Drivers who do switch off their engines may do so inefficiently. For example, a driver may switch off the engine, only to start it up a short time later. In such cases, more fuel may be consumed in restarting the engine. Some traffic signals may have clocks that indicate remaining durations before the signals change. However, drivers in vehicles waiting at the back of the queue may not be able to view the clock.

### SUMMARY

The present disclosure is directed to a method for managing engines in response to a traffic signal. The method may comprise establishing communications with a plurality of participating vehicles; responding to a stop status indicated by the traffic signal, further comprising: receiving a position data from each participating vehicles; determining a queue comprising a list of participating vehicles stopped at the traffic signal; determining a remaining duration of the stop status; sending a stop-engine notification to the list of participating vehicles stopped at the traffic signal when the remaining duration is greater than a threshold of time; responding to a proceed status indicated by the traffic signal, further comprising: sending a start-engine notification to a first vehicle in the queue; calculating an optimal time for an engine of a second vehicle in the queue to start when the first vehicle starts moving; and sending the start-engine notification to the second vehicle in the queue at the optimal time.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram illustrating a method for managing engines in response to a traffic signal; and

FIG. 2 is a flow diagram illustrating exemplary steps for reducing engine fuel consumption.

### DETAILED DESCRIPTION

Reference will now be made in detail to the subject matter disclosed, which is illustrated in the accompanying drawings.

The present disclosure is directed to a system and method for managing vehicle engines in response to a traffic signal. The method may save fuel consumption by controlling the running state of a vehicle stopped at a traffic signal. Traffic signals may include, but not limited to, traffic lights at intersections, railway crossing signals, or other devices for indicating correct moments to stop and to proceed. The method may calculate whether switching off the vehicle engine while waiting at the traffic signal reduces fuel consumption. The method may utilize various external criteria to determine the optimal time to switch off and to restart the engine.

External criteria considered may include, but not limited to, traffic signal clocks (indicating remaining wait time before changing signal), vehicle positions, traffic load information, and/or other data obtainable from sensors embedded at the intersections. It is contemplated that sensors and/or other monitoring devices may be employed at the traffic signals to obtain information regarding such external criteria. For example, weight sensors may be deployed at an intersection or a railway crossing for providing traffic load estimates. Other monitoring devices, such as cameras and GPS systems may also be utilized.

In one embodiment, the method for managing vehicle engines may comprise the ability to obtain and anticipate the wait time of a “red” light (a stop status indicated by a traffic signal). The wait time may be utilized to determine whether to switch off the engines of vehicles stopped at the traffic signal. The method may also calculate an optimal time to restart each engine in order to maximize fuel savings. For example, for a vehicle at the front of the traffic queue, the optimal time to restart the engine may be at the time when the traffic signal changes from a stop status (e.g., a red light) to a proceed status (e.g., a green light). However, additional criteria may be considered in determining the optimal time to restart the engine of a vehicle towards the back of the queue as the vehicle may need to wait for the vehicles ahead to clear first. Therefore, the method may consider moving statuses of the vehicles ahead in the queue, as well as distances between the vehicles to determine the optimal time to restart the engine for vehicles towards the back.

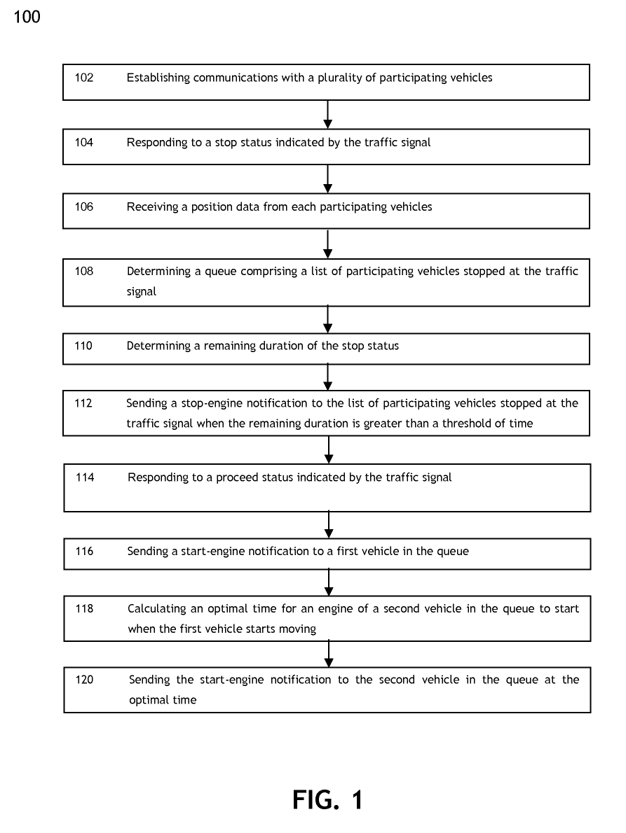

FIG. 1 shows a flow diagram illustrating the steps performed by a method 100 in accordance with the present disclosure. The method may be utilized for managing engines in response to a traffic signal. In one embodiment, the method is available as a service that vehicle drivers may sign up with to participate. The service establishes communications with the participating vehicles in step 102. The communication may be implemented utilizing wireless technologies such as Wi-Fi, cellular network, or satellite communications.

The service may operate at multiple busy intersections throughout a city or a geographical area. The service may monitor the status of traffic signals or railway crossings, and respond to a traffic signal when the traffic signal turns “red” (a stop status) in step 104. Step 106 receives position data (e.g., GPS data) from each participating vehicles. Based on the relative positions of the participating vehicles, step 108 determines a queue comprising a list of participating vehicles stopped at the traffic signal. An anticipated stoppage duration is determined in step 110 based on the wait time of the traffic signal. If the anticipated stoppage duration is less than a threshold (e.g., two minutes), no action may be necessary because switching off the engine and restart shortly after may not save fuel consumption. However, if the anticipated stoppage duration is greater than the threshold (e.g., waiting for 10 minutes for a railway to clear), step 112 may send a stop-engine notification to the list of participating vehicles stopped at the traffic signal (i.e., all vehicles in the queue determined in step 108). Upon receiving the stop-engine notification, the vehicles may automatically switch off the engine, or display an alert informing drivers to manually switch off the engines. A vehicle may optionally notify the service once its engine is switched off.

Step 114 of the service is configured to respond to the traffic signal when the status of the traffic signal is about to turn “green” (a proceed status). Step 116 sends a start-engine notification to a first vehicle in the queue. Upon receiving the start-engine notification, the first vehicle may automatically switch on the engine, or display an alert informing the driver to manually switch on the engine. Once the first vehicle starts moving (e.g., movements may be determined by road sensors and/or GPS positions), step 118 calculates an optimal time for a second vehicle in the queue to start its engine. The optimal time may be calculated based on criteria such as moving statuses of the vehicles ahead (e.g., distances between the vehicles and/or distance from the current position to the traffic signal). Step 120 sends the start-engine notification to the second vehicle at the optimal time calculated. Similarly, once the second vehicle starts moving, the service calculates the optimal time for starting the next vehicle in the queue and sends notification accordingly.

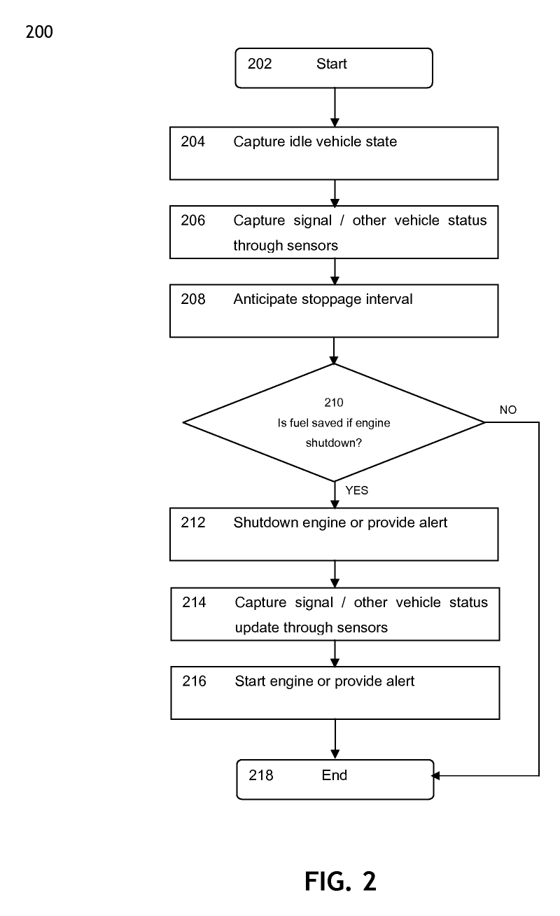

FIG. 2 shows a flow diagram illustrating exemplary steps 200 performed on a particular participating vehicle. In one embodiment, the start state 202 may be entered when the engine of the vehicle starts. Step 204 may monitor the state of the vehicle (e.g., running state or idle state), and proceed to step 206 when the vehicle reaches the idle state (e.g., when the vehicle stops at a traffic signal). Step 206 then captures and processes information/notifications received from the service and/or sensors regarding other vehicles stopped at the same traffic signal.

The participating vehicle may notify the service indicating that the vehicle has stopped at the traffic signal. The service may obtain an anticipated stoppage duration of the traffic signal in step 208. Decision state 210 determines whether switching off the engine will actually save fuel consumption based on the anticipated stoppage duration of the particular vehicle. If the determination is negative (NO), the engine may remain in idle state and the end state 218 is reached. If the determination is positive (YES), a stop-engine notification is sent to the vehicle, and step 212 may automatically switch off the engine, or alert the driver to switch off the engine manually. Step 214 continues receiving and processing information/notifications from the service and/or sensors regarding other vehicles stopped at the same traffic signal. Once a start-engine notification is received, step 216 may automatically restart the engine, or alert the driver to restart the engine manually. The steps may then be repeated again when the vehicle stops at the next traffic signal.

The present disclosure may be illustrated utilizing an example related to a railway crossing. When a participating vehicle initially stops at the crossing waiting for a train to pass, the vehicle may notify the service regarding the idle status. The service may utilize weight sensors deployed on the railroad to detect and estimate the wait time for the train to cross. If the wait time exceeds a predetermined duration, the service may send a stop-engine notification to the vehicle. Once the train passes, the sensors may determine that the train is no longer in the way, and the service may send a start-engine notification to the first participating vehicle in the queue. Once the first vehicle starts moving, the sensors on the road may detect the motion, and the participating vehicles behind will receive start-engine notifications subsequently.

It is contemplated that the method in the present disclosure may be utilized for managing vehicle engines where wait time may be anticipated and/or estimated. For example, the service may estimate a wait time for a traffic jam to clear based on traffic load information and their corresponding speed. If the service determines that the wait time for the traffics to clear exceeds a threshold, the service may notify the participating vehicles towards the back to stop their engines and restart once the traffic ahead clears.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method for managing engines in response to a traffic signal, comprising:
establishing communications with a plurality of participating vehicles;
responding to a stop status indicated by the traffic signal, further comprising:
receiving a position data from each participating vehicles;
determining a queue comprising a list of participating vehicles stopped at the traffic signal;
determining a remaining duration of the stop status;
sending a stop-engine notification to the list of participating vehicles stopped at the traffic signal when the remaining duration is greater than a threshold of time;
responding to a proceed status indicated by the traffic signal, further comprising:
sending a start-engine notification to a first vehicle in the queue;
calculating an optimal time for an engine of a second vehicle in the queue to start when the first vehicle starts moving; and
sending the start-engine notification to the second vehicle in the queue at the optimal time.
